(19) United States
(12) Patent Application Publication
(10) Pub. No.: US 2006/0186977 A1
(43) Pub. Date: Aug. 24, 2006

(54) Linear actuator, and pump device and compressor device therewith

(76) Inventor: Hideaki Ito, Nagano (JP)

Correspondence Address: CANTOR COLBURN, LLP, 55 GRIFFIN ROAD SOUTH, BLOOMFIELD, CT, 06002, US

(21) Appl. No.: 11/362,496

(22) Filed: Feb. 24, 2006

(30) Foreign Application Priority Data
Feb. 24, 2005 (JP) 2005-049093

(51) Int. Cl. H01F 7/08

(52) U.S. Cl. 335/220

(57) ABSTRACT

A linear actuator may include a driving part and a movable body. The driving part may include an inner yoke, an outer yoke disposed around the inner yoke such that a first gap space and a second gap space separated in an axial direction are formed between an outer peripheral face of the inner yoke and the outer yoke, and a coil for generating an alternating magnetic field in the first gap space and the second gap space. The movable body may be provided with a magnet that is disposed between the inner yoke and the outer yoke. The driving part may further include a coil bobbin around which the coil is wound and the coil bobbin is provided with terminals for power supply to the coil. The movable body is reciprocated in the axial direction in cooperation with the alternating magnetic field.

### CROSS REFERENCE TO RELATED APPLICATION

The present invention claims priority under 35 U.S.C. §119 to Japanese Application No. 200549093 filed Feb. 24, 2005, which is incorporated herein by reference.

### FIELD OF THE INVENTION

An embodiment of the present invention may relate to a linear actuator, and a pump device and a compressor device provided with the linear actuator.

### BACKGROUND OF THE INVENTION

A conventional pump device and a conventional compressor device in which a piston moves within a cylinder in a linear manner includes a main body part which is provided with the cylinder and a linear actuator for driving the piston. A linear motor is used to reciprocate the piston in an axial direction as a driving part which is provided in the linear actuator (see, for example, Japanese Patent Laid-Open No. 2000-337725).

A linear motor is constructed with a group of permanent magnets, a group of laminated cores and a coil, and the coil is wound around a coil bobbin and, when an alternating current is supplied to the coil, an alternating magnetic field is generated. Electrical power is normally supplied to the coil through lead wires from a power supply that is arranged outside. Therefore, after a coil has been wound around the coil bobbin, the terminal of the wound coil and the terminal of a lead wire are connected each other with hand work and temporarily fixed together and then they are conductively connected by welding or soldering. Especially, the workability of connecting the terminal of the wound coil with the terminal of the lead wire is not satisfactory because they are wires. Further, when a wire with a large diameter of wire is used to suppress a copper loss, the workability efficiency of the connection is further reduced.

### BRIEF DESCRIPTION OF THE INVENTION

In view of the problems described above, an embodiment of the present invention may advantageously provide a linear actuator which is capable of supplying power to a coil without using a lead wire to improve workability, and provide a pump device and a compressor device which utilize the linear actuator.

Thus, according to an embodiment of the present invention, there may be provided a linear actuator including a driving part comprising an inner yoke and an outer yoke which is disposed around the inner yoke, and a movable body provided with a magnet which is disposed between the inner yoke and the outer yoke. The outer yoke is disposed such that a first gap space and a second gap space separated in an axial direction are formed between an outer peripheral face of the inner yoke and the outer yoke. The driving part further includes a coil for generating an alternating magnetic field in the first gap space and the second gap space with the outer yoke, the first gap space, the inner yoke, the second gap space and the outer yoke as a magnetic path, and a coil bobbin around which the coil is wound and which is provided with terminals for power supply to the coil. The movable body is reciprocated in the axial direction in cooperation with the alternating magnetic field.

In accordance with an embodiment, the terminals for power supply comprise a pair of terminals and a pair of the terminals is disposed so that flat faces of the terminals formed of a flat plate are parallel to each other, and the terminal for power supply and the terminal of the coil are conductively connected by fusing. According to the structure described above, in order to that the terminal of the coil is conductively connected with the flat face of the terminal for power supply by fusing, fusing electrodes may be simultaneously pressurized to a pair of the terminals by moving the fusing electrodes in the same direction and thus the workability of fusing can be improved.

In this case, it is preferable that a pair of the terminals are disposed in a peripheral direction between the outer yokes at point symmetry positions of approximately 180 degrees with respect to the center of the bobbin. According to the structure described above, the distance between a pair of the terminals becomes larger without affecting the arrangement of the outer yokes. Therefore, even when a small coil bobbin is used, fusing can be easily performed because fusing electrodes can be easily arranged between a pair of the terminals. Further, even when the fixing parts for fixing the terminals to the coil bobbin is formed by integral molding, the fixing parts are arranged at point symmetry positions of 180 degrees with respect to the center of the coil bobbin, they can be formed with a simple molding die which opens in right and left directions and in up and down directions and thus a bobbin design becomes easy.

In this case, the terminal for power supply is preferably provided with a fixing part which is fixed to the coil bobbin, an engagement part with which a connector is engaged, and an extended part which is formed between the fixing part and the engagement part, and the extended part serves a holding part for holding the terminal of the coil between the flat face of the terminal for power supply and the extended part. In addition, it is further preferable that the fusing is performed between the extended part and the terminal for power supply to conductively connect the terminal for power supply and the terminal of the coil. For this purpose, an abutting projection may be preferably provided in the terminal such that the abutting projection abuts with the holding part when the terminal of the coil is held.

In accordance with an embodiment, the coil bobbin includes a barrel part around which the coil is wound and a flange part which is formed in a ring shape at its end portion in an axial direction so as to extend outside in a radial direction, and the terminal for power supply is fixed to the flange part such that the longitudinal direction of the terminal for power supply extends in the axial direction. According to the structure described above, the terminal can be arranged so as not to protrude in the radial direction of the coil bobbin, and thus the linear actuator can be miniaturized in the radial direction.

In accordance with an embodiment, it is preferable that the terminal for power supply includes a holding part for holding the terminal of the coil. According to the structure described above, the terminal of the coil can be easily fixed to the terminal for power supply. Especially, when the holding part is structured such that the terminal of the coil is pinched between the holding part and the face of the terminal, fusing can be performed with the fusing electrodes abutting from the outer sides of the holding part and the terminal.

As described above, in accordance with the present invention, the coil bobbin around which a coil is wound is provided with a terminal for power supply to the coil. Therefore, power supply to the coil is enabled without using a lead wire and thus workability can be improved.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1(A) is a longitudinal cross-sectional view showing a linear actuator in accordance with an embodiment of the present invention and FIG. 1(B) is an X-X transverse cross-sectional view of FIG. 1(A).

FIG. 2(A) is a perspective view showing a linear actuator in accordance with an embodiment which is viewed obliquely from above, and FIG. 2(B) is a perspective view showing the linear actuator that is partially cut with the line “Y-Y” in FIG. 2(A) and viewed obliquely from above.

FIG. 3 is an enlarged longitudinal cross-sectional view showing a portion of a linear actuator in accordance with an embodiment.

FIG. 4(A) is a perspective view showing a coil bobbin which is used in a linear actuator in accordance with an embodiment that is viewed obliquely from above. FIG. 4(B) is a perspective view showing a state where terminals are engaged with the coil bobbin and viewed from obliquely from above. FIG. 4(C) is an explanatory view showing an engagement structure of the terminal with the terminal of the wound coil.

FIG. 5(A) is a plan view showing a terminal which is used in a linear actuator in accordance with an embodiment. FIG. 5(B) is its front view and FIG. 5(C) is a longitudinal sectional view that is cut by the line “Z-Z”.

FIG. 6 is an exploded perspective view showing respective members structuring a linear actuator in accordance with an embodiment that are viewed obliquely from above.

FIGS. 7(A) and 7(B) are respectively explanatory views showing different operating states of the linear actuator.

FIG. 8 is a cross-sectional view showing an air pump device in accordance with an embodiment of the present invention.

### DETAILED DESCRIPTION OF THE PREFERRED EMBODIMENTS

An example of a linear actuator will be described below with reference to the accompanying drawings.

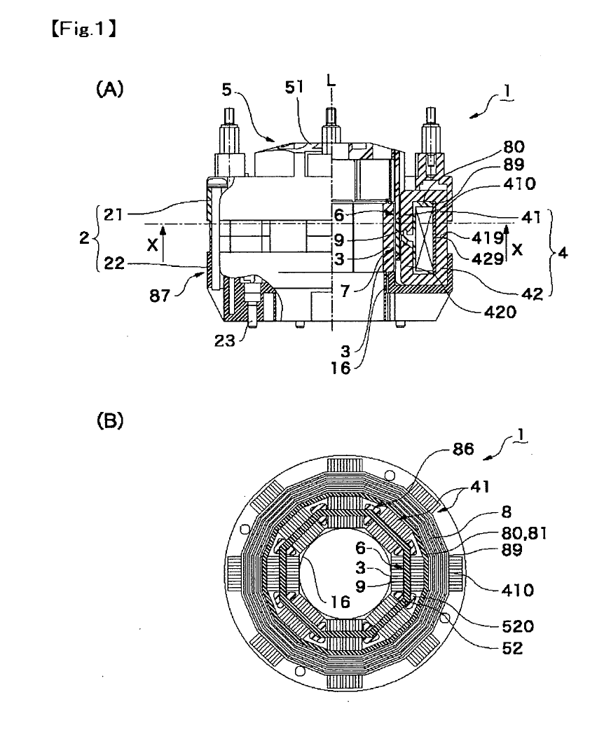

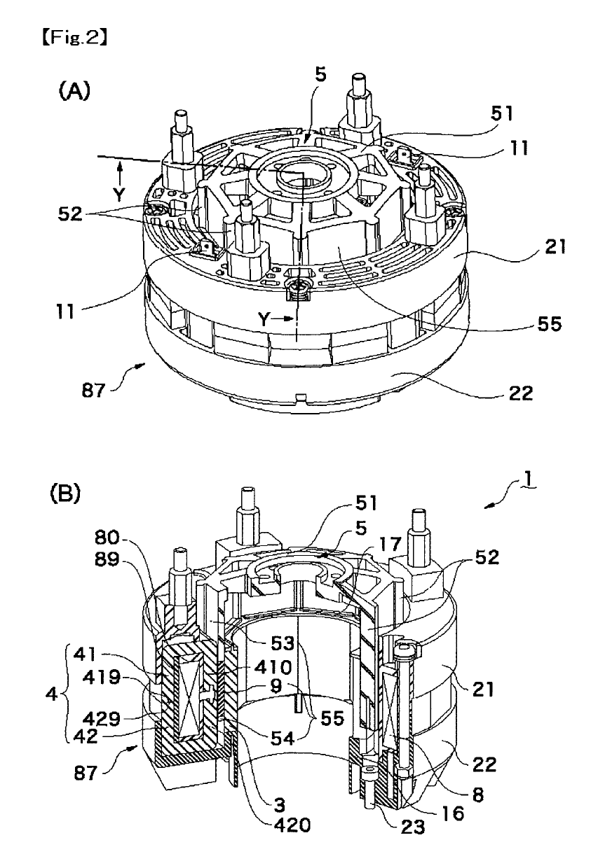

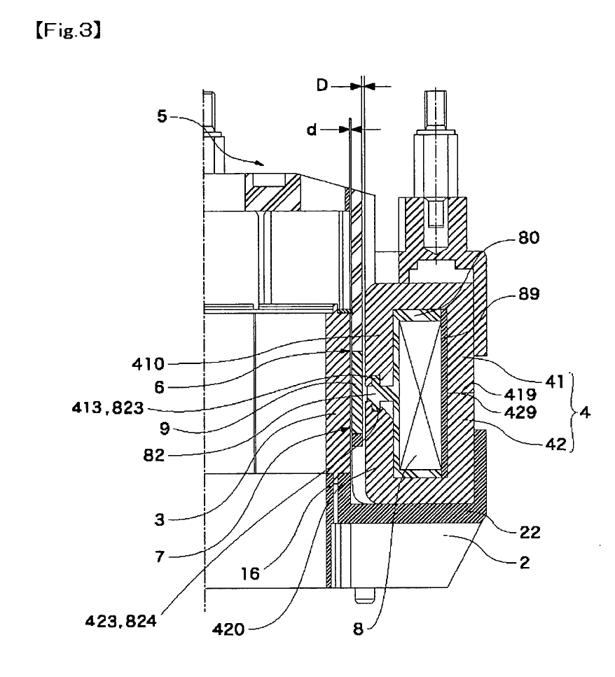

FIG. 1(A) is a longitudinal cross-sectional view showing a linear actuator in accordance with an embodiment and FIG. 1(B) is an X-X transverse cross-sectional view of FIG. 1(A). FIG. 2(A) is a perspective view showing a linear actuator in accordance with an embodiment which is viewed obliquely from above, and FIG. 2(B) is a perspective view showing the linear actuator which is partially cut with the line “Y-Y” in FIG. 2(A) and viewed obliquely from above. FIG. 3 is an enlarged longitudinal cross-sectional view showing a portion of a linear actuator in accordance with an embodiment.

A linear actuator 1 in accordance with an embodiment is used in a pump device or a compressor device for supplying various fluids. The linear actuator 1 includes a driving part 87 provided with a frame 2 which interposes and holds a stator in an axial direction and a movable body 5 which is capable of reciprocating along an axial line “L” with respect to the driving part 87.

As shown in FIGS. 1(A) and 1(B), a cylindrical part 16 in a cylindrical shape is formed in the holder 22 of the frame 2 in the driving part 87. Inner yokes 3 are fixed on the upper end of the cylindrical part 16 and one end of which is fixed to a holder body 17 formed in a ring shape. The inner yokes 3 are disposed at eight places with an equal angular interval in a circumferential direction. The inner yoke 3 is formed in a flat plate shape, and both the opposite face (outer side face) to the outer yoke 4 and its rear face (inner side face) are formed in a flat face.

Outer yokes 4 in a block shape are disposed between a pair of holders 21, 22 which serves as the frame 2 such that a first and a second gap spaces 6, 7 are formed with the opposite face of the inner yoke 3 at positions separated in an axial direction. The outer yokes 4 in a block shape are mounted between the pair of holders 21, 22 at eight places with an equal angular interval in the circumferential direction through a gap space 86 (see FIG. 1(B)). The opposite face of the outer yoke 4 to the inner yoke 3 is formed in a flat face. The opposite faces of the inner yoke 3 and the outer yoke 4 which are formed in a flat face towards each other are separated with about 3 mm and formed to be parallel.

The outer yoke 4 is constructed of two upper and lower outer yoke members 41, 42, each of which is formed in a U-shape in a longitudinal cross section. Inner side bent portions of the respective outer yoke members 41, 42 in the axial direction are a first and a second facing portions 410, 420 which face the inner yoke 3 through the first and the second gap spaces 6, 7. End parts 419, 429 which are outer side bent portions of the respective outer yoke members 41, 42 in the axial direction are abutted each other. Each of two outer yoke members 41, 42 is made of a plurality of magnetic thin plates, which are placed such that the respective end faces face the inner yoke 3 and laminated to constructed a block body. Therefore, it is advantageous that the eddy current loss is relatively small in the outer yoke 4.

As shown in FIG. 1(B) a coil 8 formed in a ring and planar shape is wound around a coil bobbin 80 and disposed in a space constructed between two outer yoke members 41, 42 of the outer yoke 4. The outer side of the coil 8 is covered with a cover 89 made of resin. The coil 8 is a common coil that is wound around to surround the entire eight outer yokes. The outer yoke members 41, 42 are, respectively, includes outer portions located on the outer peripheral side of the coil 8, middle portions passing over the end faces of the coil 8 in the axial direction, and inner bent portions in the axial direction. The tip end sides of the inner bent portions are formed to be the above-mentioned opposing parts 410, 420.

In an embodiment, the cup-shaped movable body 5 is disposed to the driving part 87 structured as described above. The movable body 5, which is a resin molded product, includes a bottom part 51 in a regular octagonal shape, elongated magnet holding parts 52 extended in the axial direction from the corner part of the bottom part 51, and sidewall parts 55 which are provided so as to close the side faces of adjacent magnet holding parts 52 as shown in FIGS. 2(A) and 2(B). In this embodiment, all side faces of the magnet holding parts 52 are closed by the sidewall parts 55 to construct a tubular shape.

As shown in FIG. 2(B) the sidewall part 55 is integrally formed with a resin wall 53, the magnet 9 and a resin wall 54 by integral molding toward the open end side from the bottom part 51. The inside and outside faces of the resin wall 53 and the resin wall 54 are respectively formed so as to be in the same plane with the both opposite faces of the magnet 9. In other words, the movable body 5 is a resin molded product in which the magnet 9 is insert molded. The magnet 9 is formed in a flat plate shape with the thickness of about 2 mm. Both faces of the magnet 9 in the thickness direction are formed to be a flat face in an exposed state, which are an opposite face (outer side) to the outer yoke 4 and an opposite face (inner side) to the inner yoke 3. The magnet 9 is a rare-earth magnet of Nd—Fe—B system or a resin magnet. The front and rear faces of the magnet 9 are magnetized in opposite polarities respectively.

As shown in FIG. 1(B), the magnet holding part 52 is formed in an approximately triangular planar shape when viewed from the axial direction. The portion corresponding to the apex of a triangle is positioned between adjacent inner yokes 3 in a wedge-shaped manner and the portion corresponding to the base side of the triangle is positioned between adjacent outer yokes 4. The magnet holding parts 52 are formed at eight positions and eight pieces of magnet 9 are held by the magnet holding parts 52 at equal angular intervals in the circumferential direction.

The movable body 5 structured as described above is disposed on the driving part 87 side as shown in FIG. 1(A), and eight pieces of magnet 9 are respectively positioned in the first and the second gap spaces 6, 7 formed by the inner yoke 3 and the outer yoke 4. In accordance with an embodiment, all eight pieces of magnet 9 which are disposed between the inner yoke 3 and the outer yoke 4 are positioned closer to the inner yoke 3 side than to the outer yoke 4. In other words, the distance “d” (see FIG. 3) between the inner yoke 3 and the opposite face of the magnet 9 that is opposite to the inner yoke 3 is set to be 0.4 mm, and the distance “D” (see FIG. 3) between the outer yoke 4 and the opposite face of the magnet 9 that is opposite to the outer yoke 4 is set to be 0.6 mm.

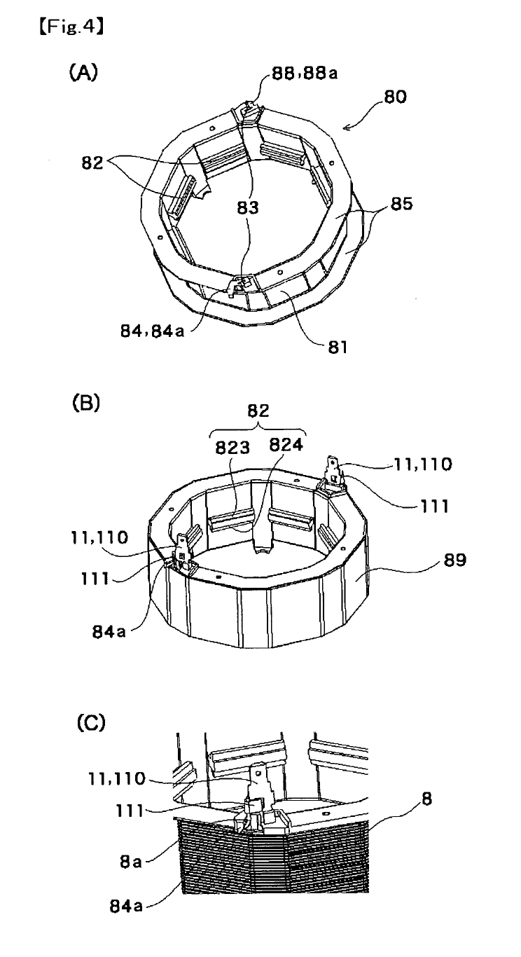

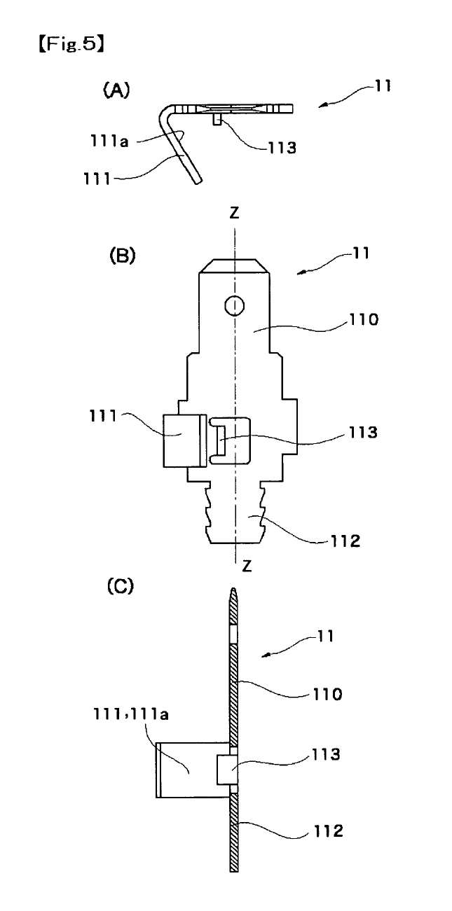

FIG. 4(A) is a perspective view showing a coil bobbin used in a linear actuator and viewed obliquely from above. FIG. 4(B) is a perspective view showing the state where a terminal for power supply is engaged with the coil bobbin viewed from obliquely from above, and FIG. 4(C) is an explanatory view showing an engagement structure of the terminal for power supply with the terminal of the wound coil. FIG. 5(A) is a plan view showing a terminal which is used in a linear actuator to which the present invention is applied, FIG. 5(B) is its front view and FIG. 5(C) is a longitudinal sectional view which is cut by the line “Z-Z” in FIG. 5(B).

In the linear actuator 1 in this embodiment, the coil bobbin 80 includes a cylindrical barrel part 81 and ring-shaped flange parts 85 which are extended outward in a radial direction from both ends of the barrel part 81. Insulation between the coil 8 and the first facing portion 410 and the second facing portion 420 of the outer yoke 4 is secured by the barrel part 81. Further, the insulation between the coil 8 and the outer yoke 4 extended over the both end faces of the coil 8 in the axial direction is secured by the flange parts 85.

A pair of press-fitting holes 83 to which terminals 11 for supplying electrical power to a coil are press-fitted and fixed is formed on the upper face of the flange part 85 at point symmetry positions of 180 degrees with respect to the center of the bobbin. Therefore, the terminals 11 are press-fitted and fixed to the press-fitting holes 83 to be arranged at point symmetry positions of 180 degrees with respect to the center of the bobbin. Further, the press-fitting holes 83 are opened at the top parts of the protruded parts 84, 88 that are protruded from the upper face of the flange part 85 in an axial direction. In addition, the turn-around protruded parts 84a, 88a which are protruded in an outer side of the flange part 85 for turning around a wound coil terminal 8a are formed in the protruded parts 84, 88.

The terminal 11 is formed of a metal flat plate. As shown in FIGS. 5(A), 5(B) and 5(C), an insertion fixing part 112 which is to be press-fitted and to be fixed to the press-fitting hole 83 is formed on one end side in its longitudinal direction and an engagement part 110 with which a connector not shown is engaged is formed on the other end side. An extended part 111, which is extended in a direction perpendicular to the longitudinal direction, is formed at a middle position between the insertion fixing part 112 and the engagement part 110. The extended part 111 is bent at its root portion and the opposite face of the extended part 111 to the flat face of the terminal 11 is formed as a holding part 111a by which the terminal 8a of wound coil is held with the flat face of the terminal 11. Further, an abutting projection 113, which is capable of abutting with the tip end side of the holding part 111a when the terminal 8a of wound coil is held, is formed so as to be bent from the terminal 11. In accordance with an embodiment, a pair of the terminals 11, 11 are formed in the same shape, and their insertion fixing parts 112 are respectively press-fitted into the press-fitting holes 83 and fixed on the upper face of the flange part 85 such that its longitudinal direction is set to be along the axial direction.

An engaging protrusion part 82 which is protruded toward the inner yoke 3 is formed on the inner peripheral face of the barrel part 81. The engaging protrusion part 82 is an engagement part which engages with both the first facing portion 410 and the second facing portion 420 and prevents the first and the second facing portions 410, 420 from being attracted to the magnet 9 to be displaced.

The engaging protrusion part 82 is provided with projections 823, 824 which are formed at the tip end of the engaging protrusion part 82 so as to protrude in the axial direction as shown in FIG. 3. On the other hand, recessed parts 413, 423 which are formed in the axial direction are formed on the tip end portion of the first facing portion 410 and the tip end portion of the second facing portion 420 respectively. Therefore, when the first and the second outer yoke members 41, 42 are overlapped on the coil bobbin 80 from both sides in the axial direction and the end parts 419, 429 of the first and the second outer yoke members 41, 42 are abutted with each other on the outer peripheral side of the coil 8, the recessed parts 413, 423 of the first and the second outer yoke members 41, 42 are fitted to the protrusion parts 823, 824 of the engaging protrusion part 82 on the inner peripheral side of the coil.

As shown in FIG. 4, the coil bobbin 80 is formed with engaging protrusion parts 82 at eight positions in the circumferential direction. In other words, eight engaging protrusion parts 82 are disposed in the circumferential direction so as to surround the inner yoke 3. Therefore, the first facing portion 410 and the second facing portion 420 are held by the coil bobbin 80 and thus they do not displace in the radial direction even when the attractive force of the magnet 9 is applied.

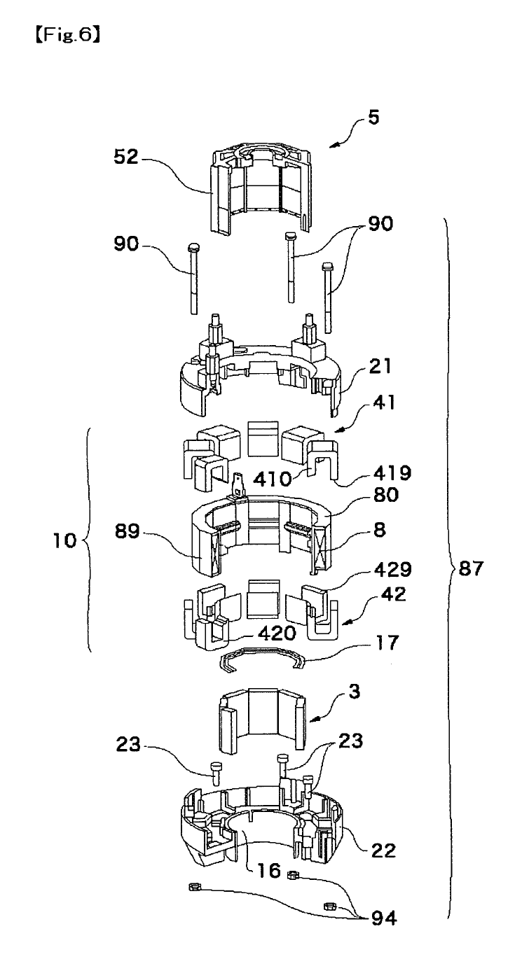

FIG. 6 is an exploded perspective view showing respective members structuring the linear actuator in accordance with an embodiment which are viewed obliquely from above.

In this embodiment, the coil 8, the coil bobbin 80 and the outer yoke members 41, 42 are assembled beforehand to be an assembled component 10. This assembled component 10 is assembled as follows. First, the press-fitting fixing part 112 of the terminal 11 is press-fitted and fixed to the press-fitting hole 83 of the coil bobbin 80 in the axial direction, and then the coil 8 is wound around the coil bobbin 80. After that, the terminal 8a of the wound coil is fixed to the terminal 11 to be conductively connected. In other words, as shown in FIG. 4(C), the terminals 8a of wound coil which are respectively turned down by the turn-around protruded parts 84a, 88a are pinched between the holding part 111a and the surface of the terminal 11, and fusing is performed from an outer side of the holding part 111a and the terminal 11 in the state that a fusing electrode is abutted, and the terminal 11 and the terminal 8a of the wound coil are conductively connected. In the fusing process, the following first step is performed. In other words, in a first step, the extended part 111 is bent by the fusing electrode such that the terminal 8a of wound coil is pinched between the holding part 111a and the surface of the terminal 11 and the top part of the abutting projection 113 and the tip end side of the extended part 111 are abutted with each other. Next, a second step is performed in which an electric current is applied to the fusing electrode to conductively connect the terminal 11 with the terminal 8a of the wound coil. Since the top part of the abutting projection 113 and the tip end side of extended part 111 are abutted, the energization for fusing can be stably performed. After that, the assembled component 10 is structured such that the first and the second outer yoke members 41, 42 are overlapped on the coil bobbin 80 from both sides in the axial direction so as to stride over the coil bobbin 80 from the upper and lower sides. In this case, the terminals 11 have been arranged at spaces between the outer yoke members 41.

The assembling of the linear actuator 1 in accordance with the above-mentioned embodiment will be performed based on the following steps. First, one end of the inner yoke 3 is fixed to the upper end of the cylindrical part 16 of the holder 22. After all the inner yokes 3 are fixed to the cylindrical part 16, the holder body 17 is engaged with the other ends of the inner yokes 3. Next, four male screws 23 for fixing the linear actuator 1 to a main body part disposed on the device side are dropped into screw holes 221 which are formed in the holder 22 and then the above mentioned assembled component 10 is dropped over the male screws 23 to set the assembled component 10 at a predetermined position of the holder 22.

The holder 21 is placed on the assembled component 10 from the upper side and then the holders 21, 22 are fixed by fixing bolts 90 and fixing nuts 91 which are disposed at four positions in the circumferential direction. In this case, the assembled component 10 is fixed to the holders 21, 22 in the state that the assembled component 10 is held by the holders 21, 22. Finally, the linear actuator 1 is structured by the movable body 5 dropped into the gap space between the inner yoke 3 and the outer yoke 4.

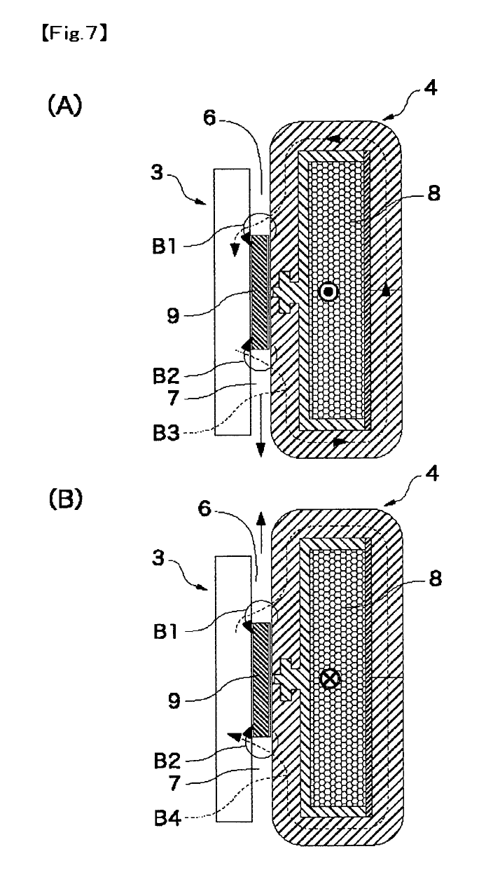

FIGS. 7(A) and 7(B) are respectively explanatory views showing different operating states of the linear actuator.

In the linear actuator 1 in accordance with an embodiment, when the inner face of the magnet 9 is magnetized at an S-pole and its outer face is magnetized at an N-pole, the magnetic field as shown by the arrows “B1”, “B2” in a solid line is generated as shown in FIGS. 7(A) and 7(B). In this state, in the case that an AC current is applied to the coil 8, when an electric current flows up from the paper surface in the drawing as shown in FIG. 7(A), the magnetic field shown by the arrow “B3” in a dotted line is generated. Therefore, the direction of the magnetic field from the magnet 9 is the same as that of the magnetic lines of force from the coil 8 in the first gap space 6. On the other hand, the direction of the magnetic field from the magnet 9 is opposite to that of the magnetic lines of force from the coil 8 in the second gap space 7. As a result, a downward force (the second gap space 7 side) in the axial direction is applied to the magnet 9.

When an electric current flows down into the paper surface in the drawing as shown in FIG. 7(B), the magnetic field shown by the arrow “B4” in a dotted line is generated. The direction of the magnetic field from the magnet 9 is opposite to that of the magnetic lines of force from the coil 8 in the first gap space 6, but the direction of the magnetic field from the magnet 9 is the same as that of the magnetic lines of force from the coil 8 in the second gap space 7. As a result, an upward force (the first gap space 6 side) in the axial direction is applied to the magnet 9.

In this manner, the direction of the force applied to the magnet 9 in the axial direction is changed corresponding to the direction of the alternating magnetic field by the coil 8. Therefore, the movable body 5 integrally provided with the magnet 9 oscillates in the axial direction and a reciprocated linear motion is outputted from the piston 130 which is attached to the movable body 5.

As described above, in an embodiment of the present invention, the linear actuator 1 includes the driving part 87 and the movable body 5. The driving part 87 includes the inner yoke 3, the outer yoke 4 which is disposed around the inner yoke 3 such that the first gap space 6 and the second gap space 7 separated in the axial direction are formed between the outer peripheral face of the inner yoke 3 and the outer yoke 4, and the coil 8 for generating an alternating magnetic field in the first gap space 6 and the second gap space 7 with the outer yoke 4, the first gap space 6, the inner yoke 3, the second gap space 7 and the outer yoke 4 as its magnetic path. The movable body 5 is provided with the magnet 9 which is disposed between the inner yoke 3 and the outer yoke 4 and is reciprocated in the axial direction in cooperation with the alternating magnetic field. In addition, the coil bobbin 80 around which the coil 8 is wound is provided with the terminals 11 for power supply to the coil 8. Therefore, power feeding to the coil 8 is enabled without using a lead wire and workability can be improved.

Further, in accordance with an embodiment, a pair of the terminals 11 is provided, and a pair of the terminals 11 and the terminals 8a of the wound coil are conductively connected by fusing. The terminals 11 are disposed such that the flat faces of the terminals formed of a flat plate are parallel to each other. Therefore, when the terminals of the wound coil 8a are fused to the flat faces of the terminals 11, fusing electrodes can simultaneously abut with the terminals 11 respectively by moving the fusing electrodes in the same direction and thus workability of fusing can be improved. Especially, in this embodiment, since the terminals 11 are arranged at point symmetry positions of 180 degrees with respect to the center of the bobbin 80, the distance between the terminals 11 becomes longer. Therefore, the fusing electrodes can be easily arranged between the terminals 11, and thus workability of fusing can be improved. Further, since the protruded parts 84, 88 and the turn-around protruded parts 84a, 88a are arranged at point symmetry positions of 180 degrees with respect to the center of the bobbin 80, they can be formed with a simple molding die which opens in right and left directions and in up and down directions.

In addition, in accordance with the above-mentioned embodiment, a pair of the terminals 11 are fixed on the surface of the flange part 85 such that its longitudinal direction is set to be along the axial direction. In other words, since the terminals 11 are arranged so as not to be protruded in the radial direction of the flange part 85, the size of the linear actuator 1 in the radial direction is not required to be larger.

Also, in accordance with the above-mentioned embodiment, the terminal 11 is provided with the holding part 11a for holding the terminal 8a of the wound coil. Therefore, when the holding part 11a is formed so as to pinch the terminal 8a of the wound coil between the surface of the terminal 11 and the holding part 11a, fusing can be performed by arranging the fusing electrodes so as to pinch the holding part 111a and the terminal 11.

In accordance with the embodiment described above, the press-fitting fixing part 112 of the terminal 11 is press-fitted and fixed to the press-fitting hole 83 of the coil bobbin 80 in the axial direction. However, the terminal 11 may be formed by being insert-molded in the coil bobbin 80.

Further, in accordance with the embodiment described above, the press-fitting hole 83 is formed such that the press-fitting fixing part 112 of the terminal 11 is inserted in the axial direction. However, the terminal may be formed in an L-shape and a press-fitting hole is formed so that the press-fitting fixing part formed on one end side of the terminal can be inserted into the press-fitting hole in a radial direction. Also in this case, the engagement part 110 formed on the other end side of the terminal is preferably fixed such that the longitudinal direction of the terminal is extended in the axial direction. In addition, in the embodiment described above, a pair of the terminals 11 are formed in the same shape but they are not required to be formed in the same shape.

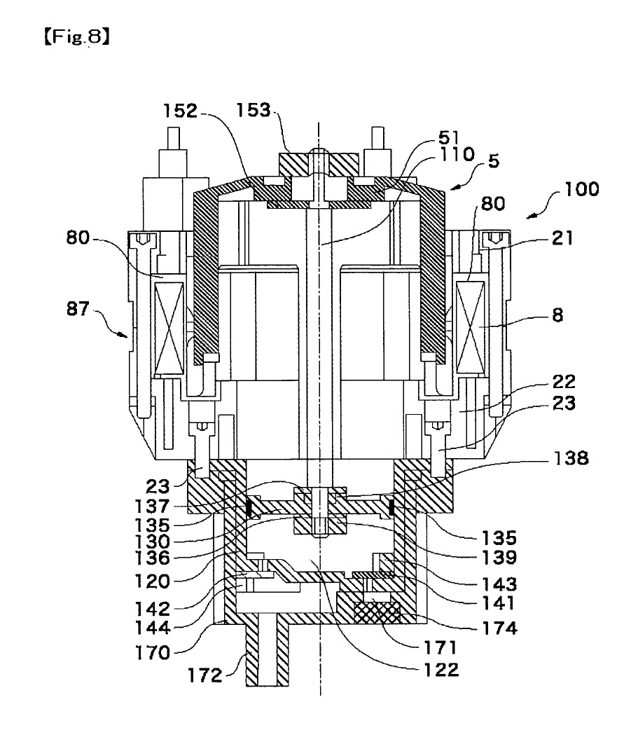

The linear actuator 1 in accordance with an embodiment may be applied to a pump device and a compressor device as described with reference to FIG. 8.

FIG. 8 is a cross-sectional view showing an air pump device in accordance with an embodiment.

In FIG. 8, in the air pump device 100 in accordance with an embodiment, the base end side of an actuating shaft 110 is connected to the movable body 5 of the linear actuator 1 with a washer 152 and a nut 153. The actuating shaft 110 is disposed so as to be passed through the cylindrical part 16 of the frame 2 which holds the inner yoke 3 as shown in FIGS. 3 and 8.

A main body side case 170 provided with an air inlet port 171 and an air outlet port 172 is fixed on the bottom part of the holder 22 in the driving part 87 with male screws 23 and a filter 174 is mounted to the air inlet port 171. A cylinder case 120 is disposed in the inside of the case 170. A valve 141 is fixed with a valve presser 143 on a portion facing the air inlet port 171 in the bottom part of the cylinder case 120 and a valve 142 is fixed with a valve presser 144 on a portion facing the air outlet port 172.

A piston 130 is disposed in the inside of the cylinder case 120 to construct the cylinder chamber 122 between the bottom part of the cylinder case 120 and the piston 130. A pressure ring 135 is mounted to the side face of the piston 130 for ensuring the air tightness with the inner peripheral side face of the cylinder case 120.

The piston 130 is fixed to the tip end portion of the actuating shaft 110 with a nut 139 through washers 136, 137 and an O-ring 138. The piston 130 is driven in the axial direction by the oscillation of the actuating shaft 110. Therefore, when the actuating shaft 110 is moved on the base end side in the axial direction (upward in the drawing) by the linear actuator 1, air is sucked into the cylinder chamber 122 from the air inlet port 171. When the actuating shaft 110 is moved on the tip end side in the axial direction (downward in the drawing) by the linear actuator 1, the air in the cylinder chamber 122 is discharged from the air outlet port 172. Further, in the embodiment of the present invention, the resonance by a spring or an externally equipped leaf spring which are not shown is utilized to the oscillation of the actuating shaft 110, and thus excellent pump characteristics can be obtained even though the air pump device 100 uses a small-sized linear actuator 1.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A linear actuator comprising:
a driving part comprising:
an inner yoke;
an outer yoke which is disposed around the inner yoke such that a first gap space and a second gap space separated in an axial direction are formed between an outer peripheral face of the inner yoke and the outer yoke;
a coil for generating an alternating magnetic field in the first gap space and the second gap space with the outer yoke, the first gap space, the inner yoke, the second gap space and the outer yoke as a magnetic path; and
a coil bobbin around which the coil is wound and which is provided with terminals for power supply to the coil; and
a movable body provided with a magnet which is disposed between the inner yoke and the outer yoke, and the movable body being reciprocated in the axial direction in cooperation with the alternating magnetic field.

2. The linear actuator according to claim 1, wherein
the terminals for power supply comprises a pair of terminals, and
a pair of the terminals is disposed so that flat faces of the terminals formed of a flat plate are parallel to each other, and
the terminal for power supply and a terminal of the coil are conductively connected by fusing.

3. The linear actuator according to claim 2, wherein
the outer yoke comprises a plurality of outer yokes which is disposed in a circumferential direction, and
a pair of the terminals is disposed between the outer yokes at point symmetry positions of roughly 180 degrees with respect to a center of the coil bobbin.

4. The linear actuator according to claim 3, wherein
the terminal for power supply is provided with a fixing part which is fixed to the coil bobbin, an engagement part with which a connector is engaged, and an extended part which is formed between the fixing part and the engagement part, and
the extended part serves a holding part for holding the terminal of the coil between the flat face of the terminal for power supply.

5. The linear actuator according to claim 4, wherein the fusing is performed between the extended part and the terminal for power supply to conductively connect the terminal for power supply and the terminal of the coil.

6. The linear actuator according to claim 4, wherein the terminal for power supply is provided with an abutting projection which abuts with the holding part when the terminal of the coil is held between the extended part and the terminal for power supply.

7. The linear actuator according to claim 1, wherein
the bobbin includes a barrel part around which the coil is wound and a flange part which is formed at an end portion in an axial direction in a ring shape so as to extend outside in a radial direction, and
the terminal for power supply is fixed to the flange part such that a longitudinal direction of the terminal for power supply is extended in the axial direction.

8. The linear actuator according to claim 1, wherein the terminal for power supply includes a holding part for holding the terminal of the coil.

9. A pump device comprising:
a linear actuator comprising:
a driving part comprising:
an inner yoke;
an outer yoke which is disposed around the inner yoke such that a first gap space and a second gap space separated in an axial direction are formed between an outer peripheral face of the inner yoke and the outer yoke;
a coil for generating an alternating magnetic field in the first gap space and the second gap space with the outer yoke, the first gap space, the inner yoke, the second gap space and the outer yoke as a magnetic path; and
a coil bobbin around which the coil is wound and which is provided with terminals for power supply to the coil; and
a movable body provided with a magnet which is disposed between the inner yoke and the outer yoke, and the movable body being reciprocated in the axial direction in cooperation with an alternating magnetic field.

10. The pump device according to claim 9, wherein
the terminals for power supply comprises a pair of terminals, and
a pair of the terminals is disposed so that flat faces of the terminals formed of a flat plate are parallel to each other, and
the terminal for power supply and a terminal of the coil are conductively connected by fusing.

11. A compressor device comprising:
a linear actuator comprising:
a driving part comprising:
an inner yoke;
an outer yoke which is disposed around the inner yoke such that a first gap space and a second gap space separated in an axial direction are formed between an outer peripheral face of the inner yoke and the outer yoke;
a coil for generating an alternating magnetic field in the first gap space and the second gap space with the outer yoke, the first gap space, the inner yoke, the second gap space and the outer yoke as a magnetic path; and
a coil bobbin around which the coil is wound and which is provided with terminals for power supply to the coil; and
a movable body provided with a magnet which is disposed between the inner yoke and the outer yoke, and the movable body being reciprocated in the axial direction in cooperation with the alternating magnetic field.

12. The compressor device according to claim 11, wherein
the terminals for power supply comprises a pair of terminals, and
a pair of the terminals is disposed so that flat faces of the terminals formed of a flat plate are parallel to each other, and
the terminal for power supply and a terminal of the coil are conductively connected by fusing.
